(19) United States
(12) Patent Application Publication
(10) Pub. No.: US 2007/0151867 A1
(43) Pub. Date: Jul. 5, 2007

(54) Apparatus and a method for electrochemical mechanical processing with fluid flow assist elements

(75) Inventors: Yongqi Hu, San Jose, CA (US); Stan D. Tsai, Fremont, CA (US); Gerald Alonzo, Los Gatos, CA (US); Lakshmanan Karuppiah, San Jose, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/431,231

(22) Filed: May 10, 2006

Related U.S. Application Data
(63) Continuation-in-part of application No. 11/327,527, filed on Jan. 5, 2006.

(51) Int. Cl. B23H 9/14; C25F 3/00; B23H 3/00

(52) U.S. Cl. 205/665

(57) ABSTRACT

An apparatus and a method with fluid flow assist elements for electrochemical mechanical processing is provided in this invention. In one embodiment, the apparatus includes a first conductive layer having an upper surface adapted to contact a substrate, a second conductive layer disposed below the first conductive layer, an isolation layer disposed between the conductive layers, and a plurality of apertures, each having a first end formed through the first conductive layer and a second end formed through the second conductive layer, wherein the second ends of at least two apertures are laterally coupled by a channel.

### CROSS-REFERENCE TO RELATED APPLICATIONS

This application is a continuation-in-part of U.S. patent application Ser. No. 11/327,527, entitled “Fully Conductive Pad for Electrochemical Mechanical Processing,” filed on Jan. 5, 2006, which is herein incorporated by reference in its entirety.

### BACKGROUND OF THE INVENTION

1. FIELD OF THE INVENTION

Embodiments of the present invention generally relate to a processing apparatus for planarizing or polishing a substrate. More particularly, the invention relates to polishing pad design with fluid flow assist elements for planarizing or polishing a semiconductor wafer by electrochemical mechanical planarization.

2. DESCRIPTION OF THE RELATED ART

In the fabrication of integrated circuits and other electronic devices on substrates, multiple layers of conductive, semiconductive, and dielectric materials are deposited on or removed from a substrate, such as a semiconductor wafer. As layers of materials are sequentially deposited and removed, the substrate may become non-planar and require planarization, in which previously deposited material is removed from the substrate to form a generally even, planar or level surface. The process is useful in removing undesired surface topography and surface defects, such as rough surfaces, agglomerated materials, crystal lattice damage and scratches. The planarization process is also useful in forming features on the substrate by removing excess deposited material used to fill the features and to provide an even or level surface for subsequent deposition and processing.

Electrochemical Mechanical Planarization (ECMP) is one exemplary process which is used to remove materials from the substrate. ECMP typically uses a polishing pad having conductive elements and combines physical abrasion with electrochemical activity that enhances the removal of materials. The polishing pad is attached to an apparatus having a rotating platen assembly that is adapted to couple the pad to a power source. The apparatus also has a substrate carrier, such as a polishing head, that is mounted on a carrier assembly above the pad that holds a substrate. The polishing head places the substrate in contact with the polishing pad and is adapted to provide downward pressure, controllably urging the substrate against the polishing pad. The polishing pad is moved relative to the substrate by an external driving force. A polish fluid, such as an electrolyte, is typically provided to the surface of the polishing pad which enhances electrochemical activity between the polishing pad and the substrate. The ECMP apparatus may affect abrasive and/or polishing activity from frictional movement while the electrolyte combined with the conductive properties of the polishing pad selectively removes material from the substrate.

FIG. 8 depicts a simplified conventional pad 806. As a number of substrates are polished, contaminants and byproduct associated with the electrochemical polishing reaction may be generated. Contaminants 810 may accumulate on apertures 808 of the polishing pad 806 and/or on the upper surface of the conductive electrodes 804. The contaminants 810 insulate the conductive electrodes 804 from the process fluid, thereby adversely influencing the electrochemical activity between the conductive electrodes 804 and substrate. As apertures 808 are blind holes, it is difficult to flush contaminants 810 disposed in the apertures 808 from the pad 806. When some of the accumulated contaminants 810 disposed in the apertures 808 to the surface of the polishing pad 806, the contaminants 810 detrimentally generate defects in a substrate surface during polishing. Additionally, the accumulated contaminants may disadvantageously deteriorate the conductivity of the conductive electrodes and the qualities of the polishing pad, resulting in consumable part lifetime degradation and higher process cost.

Therefore, there is a need for an improved polishing pad.

### SUMMARY OF THE INVENTION

An apparatus and a method for electrochemical mechanical processing are provided in the embodiments of the present invention. In one embodiment, the apparatus includes a first conductive layer having an upper surface adapted to contact a substrate, a conductive carrier coupled to and disposed below the first conductive layer, a second conductive layer disposed below the conductive carrier with an isolation layer therebetween, and a plurality of fluid flow assist elements disposed below the second conductive layer.

In another embodiment, an apparatus includes a rotatable platen having a removable pad assembly disposed thereon. A fluid delivery is positionable to provide a process fluid to an upper surface of the pad assembly. The pad assembly includes a first conductive layer adapted to contact a substrate, a second conductive layer, an isolation layer separates the conductive layers, and a plurality of fluid flow assist elements defining a lateral flow network defined between the pad assembly and the platen.

In yet another embodiment, the method includes contacting a surface of a pad assembly disposed on a platen with a substrate, flowing process fluid from the surface of the pad assembly through apertures towards the platen and into contact with an electrode, draining the apertures, and biasing the substrate relative to the electrode.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top view of one embodiment of a processing system;

FIG. 2A is a sectional view of an exemplary ECMP station with a fluid flow assist element disposed in a pad assembly;

FIG. 2B is an exploded view of one embodiment of a portion of the pad assembly shown in FIG. 2A;

FIG. 3 is a schematic side view of a portion of one embodiment of a pad assembly with a fluid flow assist element;

FIGS. 4-7 are alternative embodiment of pad assemblies having fluid assist element defined therein; and

FIG. 8 is a partial sectional view of a conventional pad assembly.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAIL DESCRIPTION

Embodiments of the present invention generally describe a pad assembly having fluid flow assist elements that aid the dynamic flow and circulation of the process fluid through the pad assembly. The fluid flow assist elements facilitate the release and cleaning of the processing byproduct by providing channels defined between the fluid flow assist elements, thus sweeping byproduct from the pad assembly and maintaining more stable electrochemical environment in the system.

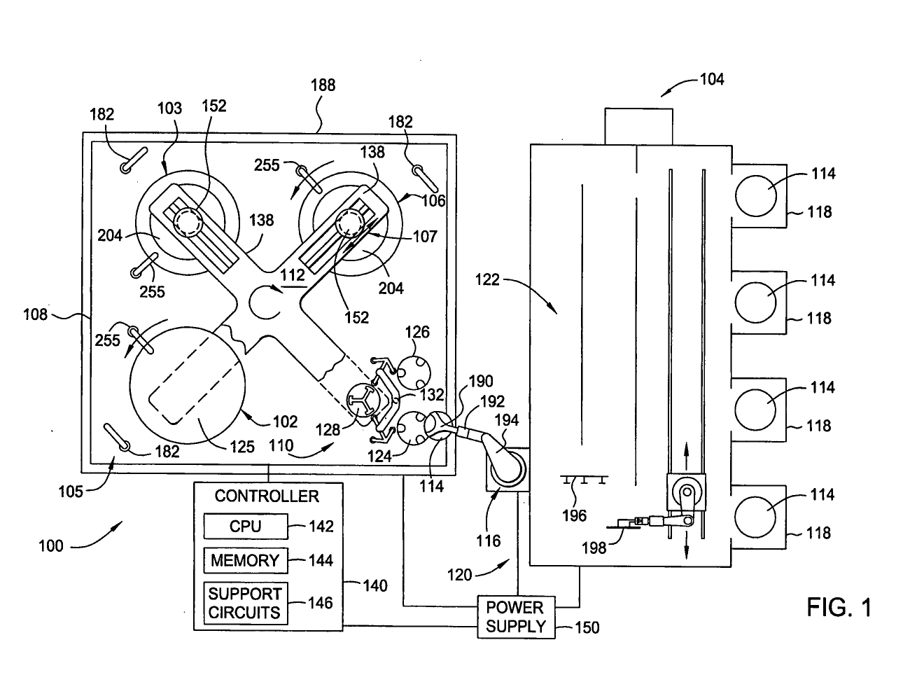

FIG. 1 depicts a plan view of one embodiment of a processing system 100 generally having a factory interface 120, a loading robot 116, and one or more polishing modules 105. Generally, the loading robot 116 is disposed proximate the factory interface 120 and the polishing module 105 to facilitate the transfer of substrates 114 therebetween. The polishing module 105 generally includes at least a first electrochemical mechanical planarization (ECMP) station 102, and optionally, at least one conventional chemical mechanical planarization (CMP) station 106 disposed in an environmentally controlled enclosure 188. An example of a processing system 100 that may be adapted to practice the invention is the REFLEXION® LK Ecmp system available from Applied Materials, Inc. located in Santa Clara, Calif. Other planarizing modules, including that from other manufactures, may be adapted to practice the invention.

The planarizing module 105 shown in FIG. 1 includes a first ECMP station 102, a second ECMP station 103, and one CMP station 106. It is to be understood that the invention is not limited to this configuration and that all of the stations 102, 103, and 106 may be adapted to use an ECMP process to remove various layers deposited on the substrate. Alternatively, the planarizing module 105 may include two stations that are adapted to perform a CMP process while another station may perform an ECMP process. In one exemplary process, a substrate having feature definitions lined with a barrier layer and filled with a conductive material disposed over the barrier layer may have the conductive material removed in two steps in the two ECMP stations 102, 103, with the barrier layer processed in the conventional CMP station 106 to form a planarized surface on the substrate. It is to be noted that the stations 102, 103, and 106 in any of the combinations mentioned above may also be adapted to deposit a material on a substrate by an electrochemical and/or an electrochemical mechanical plating process.

The exemplary system 100 generally includes a base 108 that supports one or more ECMP stations 102, 103, one or more CMP stations 106, a transfer station 110, conditioning devices 182, and a carousel 112. The transfer station 110 generally facilitates transfer of substrates 114 to and from the system 100 via a loading robot 116. The loading robot 116 typically transfers substrates 114 between the transfer station 110 and the factory interface 120.

The factory interface 120 generally includes a cleaning module 122, a metrology device 104 and one or more substrate storage cassettes 118. An interface robot 198 is employed to transfer substrates 114 between the substrate cassettes 118, the cleaning module 122 and an input module 196. The input module 196 is positioned to facilitate transfer of substrates 114 between the polishing module 106 and the factory interface 122 by the loading robot 116. For example, unpolished substrates 114 retrieved from the cassettes 118 by the interface robot 120 may be transferred to the input module 196 where the substrates 114 may be accessed by the loading robot 116 for loading to the polishing module 105, while polished substrates 114 returning from the polishing module 105 may be placed in the input module 196 by the loading robot 116. Polished substrates 114 are typically passed from the input module 196 through the cleaning module 122 before the factory interface robot 198 returns the cleaned substrates 114 to the cassettes 118. An example of such a factory interface 122 that may be used to advantage is disclosed in U.S. Pat. No. 6,361,422, issued Mar. 26, 2002, which is hereby incorporated by reference.

The loading robot 116 is generally positioned proximate the factory interface 122 and the polishing module 105 such that the range of motion provided by the robot 116 facilitates transfer of the substrates 114 therebetween. An example of a loading robot 104 is a 4-Link robot, manufactured by Kensington Laboratories, Inc., located in Richmond, Calif.

The exemplary loading robot 116 has an articulated arm 194 having a rotary actuator 192 at its distal end. An edge contact gripper 190 is coupled to the rotary actuator 192. The rotary actuator 192 permits the substrate 114 secured by the gripper 190 to be oriented in either a vertical or a horizontal orientation without contacting the feature side of the substrate 114 and possibly causing scratching or damage to the exposed features. Additionally, the edge contact gripper 190 securely holds the substrate 114 during transfer, thus decreasing the probability that the substrate 114 will become disengaged. Optionally, other types of grippers, such as electrostatic grippers, vacuum grippers and mechanical clamps, may be substituted.

The transfer station 110 comprises at least an input buffer station 124, an output buffer station 126, a transfer robot 132, and a load cup assembly 128. The loading robot 116 places the substrate 114 onto the input buffer station 124. The transfer robot 132 has two gripper assemblies, each having pneumatic gripper fingers that hold the substrate 114 by the substrate's edge. The transfer robot 132 lifts the substrate 114 from the input buffer station 124 and rotates the gripper and substrate 114 to position the substrate 114 over the load cup assembly 128, then places the substrate 114 down onto the load cup assembly 128. An example of a transfer station that may be used is described in U.S. Pat. No. 6,156,124, issued Dec. 5, 2000, entitled “Wafer Transfer Station for a Chemical Mechanical Polisher,” incorporated herein by reference to the extent it is not inconsistent with this application.

The carousel 112 generally supports a plurality of carrier heads 152, each of which retains one substrate 114 during processing. The carousel 112 moves the carrier heads 152 between the transfer station 110 and stations 102, 103 and 106. One carousel that may used is generally described in U.S. Pat. No. 5,804,507, issued Sep. 8, 1998, entitled “Radially Oscillating Carousel Processing System for Chemical Mechanical Polishing,”which is hereby incorporated by reference to the extent it is not inconsistent with this application.

To facilitate control of the polishing system 100 and processes performed thereon, a controller 140 comprising a central processing unit (CPU) 142, memory 144 and support circuits 146 is connected to the polishing system 100. The CPU 142 may be one of any form of computer processor that can be used in an industrial setting for controlling various drives and pressures. The memory 144 is connected to the CPU 142. The memory 144, or computer-readable medium, may be one or more of readily available memory such as random access memory (RAM), read only memory (ROM), floppy disk, hard disk, or any other form of digital storage, local or remote. The support circuits 146 are connected to the CPU 142 for supporting the processor in a conventional manner. These circuits include cache, power supplies, clock circuits, input/output circuitry, subsystems, and the like.

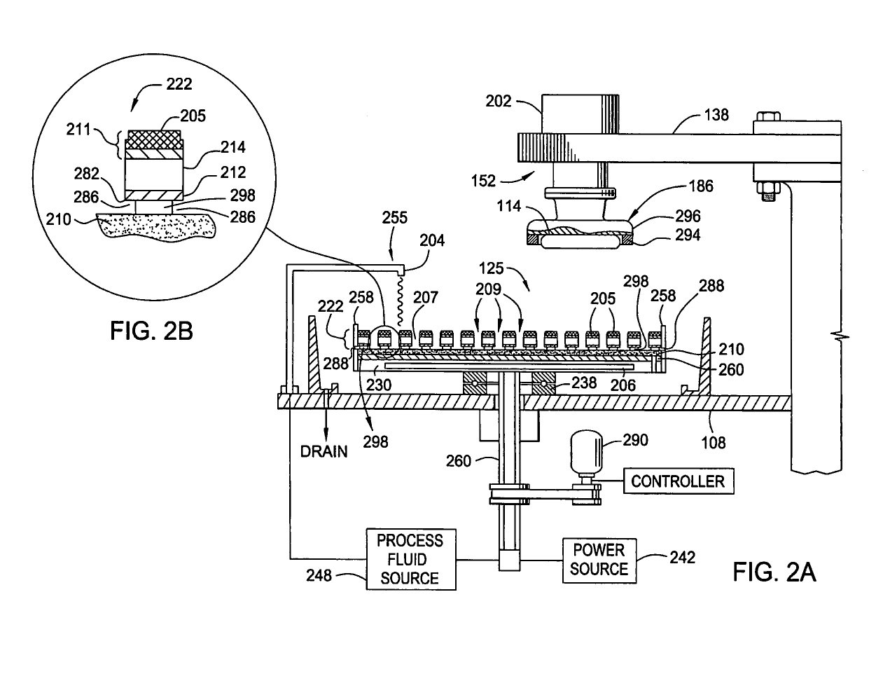

FIG. 2A depicts a sectional view of an exemplary ECMP station 102. The carrier head assembly 152 generally comprises a drive system 202 coupled to a carrier head 186. The drive system 202 generally provides at least rotational motion to the carrier head 186. The drive system 202 moves the carrier head 186 with at least a rotary, orbital, sweep motion or combinations thereof.

Generally, the carrier head 186 comprises a housing 296 and retaining ring 294 that defines a center recess in which the substrate 114 is retained. The retaining ring 294 circumscribes the substrate 114 disposed within the carrier head 186 to prevent the substrate from slipping out from under the carrier head 186 while processing. The retaining ring 294 can be made of plastic materials such as PPS, PEEK, and the like, or conductive materials such as stainless steel, Cu, Au, Pd, and the like, or some combination thereof. It is further contemplated that a conductive retaining ring 294 may be electrically biased to control the electric field during processing. In one embodiment, the carrier head may be a TITAN HEAD™ or TITAN PROFILER™ wafer carrier manufactured by Applied Materials, Inc. It is contemplated that other carrier head 186 may be utilized to use in the polishing system 100.

The platen assembly 230 is rotationally disposed on a base 108 and supports a pad assembly 222. The platen assembly 230 is supported above the base 108 by a bearing 238 so that the platen assembly 230 may be rotated relative to the base 108. An area of the base 108 circumscribed by the bearing 238 is open and provides a conduit for the electrical, mechanical, pneumatic, control signals and connections communicating with the platen assembly 230.

Conventional bearings, rotary unions and slip rings, collectively referred to as rotary coupler 260, are provided such that electrical, mechanical, fluid, pneumatic, control signals and connections may be coupled between the base 108 and the rotating platen assembly 230. The platen assembly 230 is typically coupled to a motor 290 that provides the rotational motion to the platen assembly 230. The motor 290 controls the rotational speed and direction of the platen assembly 230.

A process fluid delivery system 255 is generally disposed adjacent the platen assembly 230. The process fluid delivery system 255 includes a nozzle or outlet 204 coupled to a process fluid source 248. The outlet 204 flows process fluid, such as electrolyte, from the process fluid source 248 onto the process surface 125 of the pad assembly 222. During processing, the process fluid generally provides an electrical path for biasing the substrate 114 and driving an electrochemical process to remove and/or deposit material on the substrate 114. Alternatively, it is contemplated that the process fluid may be delivered from other portion of the system, such as from the bottom of the platen 230, to the processing surface 125 of the pad assembly 222 to provide a uniform distribution of the process fluid on the surface of the pad assembly.

The processing pad assembly 222 is coupled to the platen assembly 230 and is configured to receive an electrical bias to drive a plating process and/or an electrochemical mechanical polishing/planarizing process. In one embodiment, the processing pad assembly 222 may be adapted to releasably couple to an upper surface 260 of the platen assembly 230. The pad assembly 222 may be bound to the upper surface 260 by the use of pressure and/or temperature sensitive adhesives, allowing replacement of the pad assembly 222 by peeling the pad assembly from the upper surface 260. In another embodiment, the upper surface 260 of the platen assembly 230, having the processing pad assembly 222 coupled thereto, may be adapted to releasably couple to the platen assembly 230 via fasteners, such as screws, clamps, magnetic force, vacuum, and electrostatic attraction, among others.

In the embodiment shown in FIG. 2A, the process fluid provided from the outlet 204 may form a bath that is bounded by a platen lip 258 adapted to contain a suitable processing level of process fluid while rotating. Alternatively, the process fluid may be provided by outlet 204 continuously or at intervals to maintain a suitable level of process fluid in the apertures of the processing pad assembly 222. After the process fluid has reached its processing capacity and is ready for replacement, the platen assembly 230 may be rotated at a higher rotational speed and the spent process fluid is released by the action of centrifugal force over the platen lip 258. In another embodiment, the platen assembly 230 is rotated at a higher rotational speed and the spent process fluid is released through perforations 288 in the platen lip 258 that may be opened and closed by an operator or controller. In another embodiment, spent process fluid may be drained through passages formed through various layers of the pad assembly 222 and/or the platen assembly 230.

FIG. 2B is an exposed view of a portion of the pad assembly 222 of FIG. 2A. The pad assembly 222 generally includes a first conductive layer 211 and a second conductive layer 212 with an isolation layer 214 disposed therebetween to electrically isolate the first and second conductive layers 211, 212. A plurality of apertures 209 are formed by the open areas of the first conductive layer 211 on the upper surface of the pad assembly 222. Each aperture has a first end formed through the open area of the first conductive layer 211 and a second end formed through the second conductive layer 212 defining a functional cell 207 which is configured to receive a process fluid. Each of the functional cells 207 are adapted to perform as an electrochemical cell when the process fluid is provided to the pad assembly 222, and a differential electrical bias is applied to the first conductive layer 211 and the second conductive layer 212.

The first conductive layer 211 and the second conductive layer 212 are generally fabricated from a highly conductive material, such as noble metals, soft and corrosion resistive metals, stainless steel, polymer conductive material, aluminum and copper, among others. Altematively, the first conductive layer 211 grooves in the upper surface 205 and are made from a conductive material configured to communicate an electrical bias from an upper portion of the pad assembly 222. In one embodiment, the upper surface of first conductive layer 205 may be fabricated from a conventional polishing material, such as polymer based pad materials compatible with the process chemistry, examples of which include polyurethane, polycarbonate, fluoropolymers, PTFE, PTFA, polyphenylene sulfide (PPS), or combinations thereof. The conventional polishing material may be coated, doped, or impregnated with a process compatible conductive material and/or particles. Alternatively, the conductive material may be a conductive polymer, such as a conductive or dielectric filler material disposed in a conductive polymer matrix or a conductive fabric. In one embodiment, the conductive material is a polymer matrix having a plurality of conductive particles disposed therein.

The isolation layer 214 may be made of a soft material that is configured to provide compressibility to the pad assembly 222. The isolation layer may be made of a polymer material, such as an open cell foamed polymers, closed cell foamed polymers, a MYLAR® material, heat activated adhesives, or combinations thereof The isolation layer 214 may have a hardness of about 60 Shore A to about 100 Shore A.

The first end of the apertures 209 exits the first conductive layer 211 below the upper surface 205 within the groove. The second end of at least two apertures 209 defined in the electrical functional cells 207 are laterally coupled to each other through a channel 286. The channel 286 is formed as an internal passage defined by the second conductive layer 212, a plurality of posts 298 and a pad base 210. In embodiments wherein the pad base 210 is not present, the channel 286 may be alternatively defined between the second conductive layer 212, the post 298 and the platen assembly 260. The plurality of posts 298 maintains the pad base 210 and the second conductive layer 212 in a spaced-apart relation, thereby allowing the cannels 286 defined therein at least being partially bound by the posts 298. The channel 286 has a flow path extending outward of the second conductive layer 212 and acts as fluid assist element facilitating the circulation and dynamic flow of the process fluid, thereby preventing the spent process fluid accumulating on the second conductive layer 212. The channels 286 laterally couples at least two apertures 209 formed in the pad assembly 222. In the embodiment depicted in FIGS. 2A-B, the diameter and/or width of the posts 298 have a diameter substantially smaller than the width and/or diameter of the second conductive layer 212 to create a recessed area between a bottom surface of the second conductive layer 212 and a lateral side of the post 298 for the defining the channel 286 among the posts 298. The channel 286 assists the spent process fluid and byproducts in the functional cell 207 to be cleaned and flushed out through the perforations 288 in the platen lip 258. As such, the contaminant or byproduct associated with the spent process fluid or electrochemical reaction can be efficiently flushed, thereby preventing it from accumulating and trapping on the periphery of the second conductive layer 212.

The size and distribution of each of the plurality of channels 286 may be varied according to the configuration of the posts 298. For example, the height of the posts 298 defining the channels 286 may be varied as needed. The number, size, sectional shape, distribution, open area and pattern density of the posts 298 may be selected and distributed as needed. In one embodiment, the post 298 has a substantially cylindrical shape.

The posts 298 may be made of a material that resists from process byproduct accumulation. In one embodiment, the posts 298 may be made of a polymer material, such as a polymer or a plastic material. Suitable examples of the material include, but not limited to, PPS, PVC, chlorinated PVC, and the like. In another embodiment, the posts 298 may be made of a conductive material, such as noble metals, stainless steel, magnets, aluminum and copper among others. In yet another embodiment, the posts may be made of any material as needed.

The pad base 210 may be an article support layer that provides additional rigidity to the pad assembly 222. In one embodiment, the pad base 210 may be fabricated from polymeric materials, for example, polyurethane and polyurethane mixed with fillers, polycarbonate, polyphenylene sulfide (PPS), ethylene-propylene-diene-methylene (EPDM), fluoropolymer, or combinations thereof, and other polishing materials used in polishing substrate surfaces, such as open or closed-cell foamed polymer, elastomers, felt, impregnated felt, plastics, and like materials compatible with the processing chemistries. In one embodiment, the pad base 210 is a polyethylene terephthalate (PET) material, and derivatives thereof, such as a MYLARF® polymer sheet. The PET material has a density between about 1.25 grams/cm² to about 1.45 grams/cm² and a modulus of elasticity between about 700,000 psi to about 760,000 psi. The pad base 210 material may have a hardness of about 30 Shore A to about 90 Shore A, and is typically harder than the isolation layer 214.

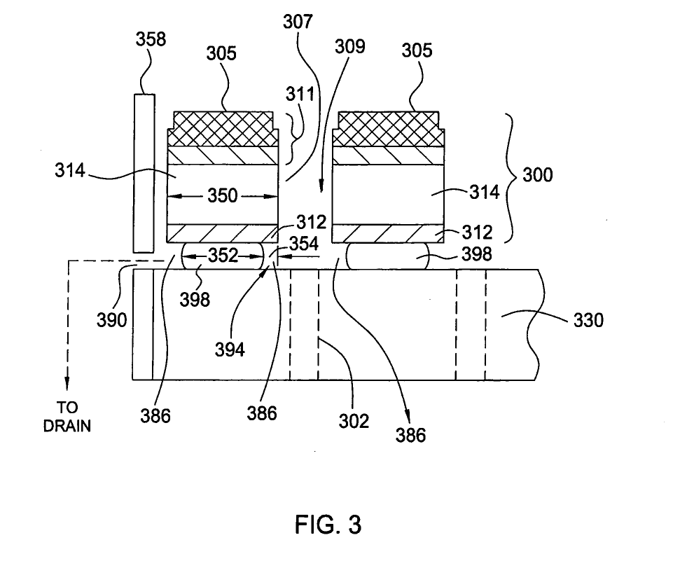

FIG. 3 is a schematic side view of a portion of one embodiment of a pad assembly 300 with fluid flow assist element defined therein. The pad assembly 300 comprises a plurality of apertures 309 having a first end formed through a first conductive layer 311 and a second end formed through a second conductive layer 312, an isolation layer 314 disposed between the first and second conductive layer 311, 312, and channels 386 defined to laterally couple at least two apertures 309. Each of the first and second conductive layers 311, 312 are adapted to couple to a power source 342 that is adapted to supply different electrical voltages to each of the first and second conductive layers. The second conductive layer 312 may provide one electrical signal that is distributed globally within the respective layer, or may comprise multiple independent electrical zones isolated from each other. The independent zones receive separate and independent voltages and adjacent zones are insulated from each other in order to provide varying voltages to specific portions of the respective layer.

In the embodiment depicted in FIG. 3 as the optional pad base is not present, a plurality of posts 398 may be coupled between the second conductive layer 312 and a platen assembly 330 and maintains the platen assembly 330 and the second conductive layer 312 in a spaced-apart relation. The plurality of posts 398 creates an area of the recesses 394 at the lateral side of the posts, thereby defining the channels 386 as fluid assist element to facilitate the flow of the process fluid. The cannels 386 defined therein are at least partially bound by the posts 398. The posts 398 may be melded, adhered, magnetically attracted, clamped, fastened, secured or other suitable methods to the second conductive layer 312.

The posts 398 are configured to have a diameter 352 and/or width smaller than the width 350 of the second conductive layer 350, thereby defining an extended recessed area 354 to form the channels 386 between the upper surface of the platen assembly 330 and the bottom surface of the second conductive layer.

In a typical ECMP polishing process, byproducts, such as materials removed from the substrate and/or materials that are removed from the pad assembly 300 by contact with the substrate, tend to accumulate in a lower portion of the pad assembly 300. These byproducts may accumulate on the conductive layer 312 performing as the cathode in the ECMP process, or near the conductive layer, such as the channels 386, thus decreasing electrochemical activity and material removal from the substrate. As the byproduct and spent process fluid accumulated in the channels 386, the platen assembly 330 may be periodically rotated at a higher rotational speed and the byproduct and spent process fluid may be released through perforations 390 in the platen lip 358 as needed. The channels 386 allows the byproduct to be released therefrom, preventing the contaminant restrained, accumulated or trapped on the second conductive layer 312 as the platen assembly 330 rotates, thus maintaining more stable electrochemical activity within each of the plurality of functional cells 307. Additionally, channels 386 prevent the contaminants and particles accumulated on the surface of the first conductive layer 311, eliminating defects generation to substrates processed thereon. Alternatively, byproduct and spent process fluid may be released through at least one perforation 302 performing as a drain formed through pad base 310 and/or the platen assembly 330. The consistent electrochemical activity may provide a higher removal rate, and/or an improved consistency in the removal rate, thus decreasing process time and increasing throughput.

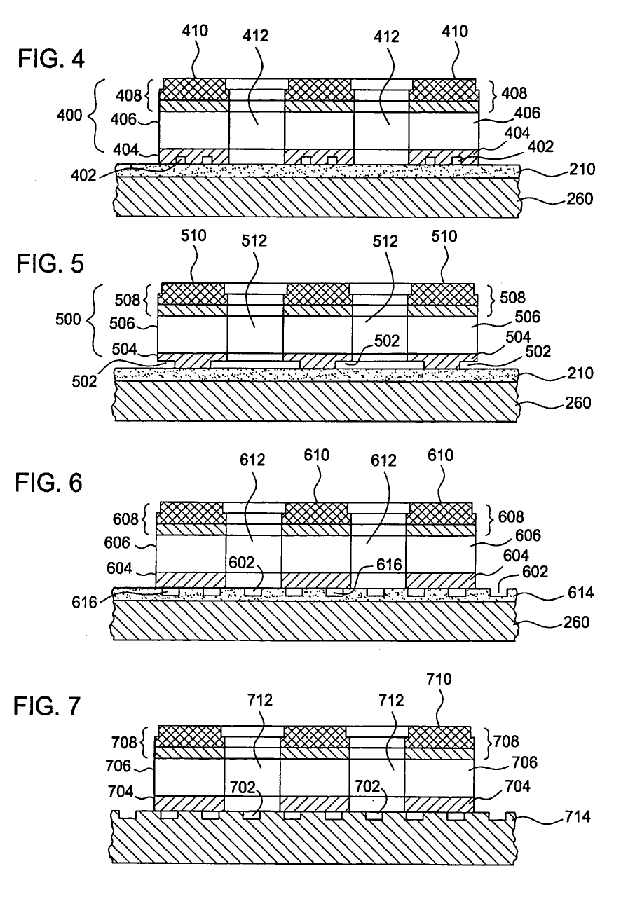

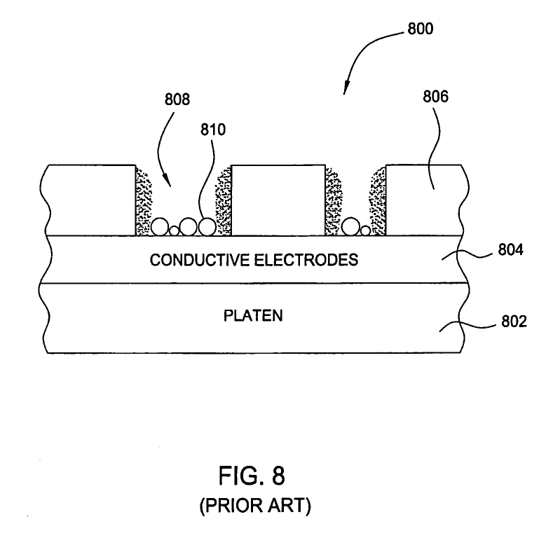

FIGS. 4-7 depicts different embodiments of pad assemblies with fluid flow assist element defined therein. In the embodiment depicted in FIG. 4, the pad assembly 400 includes a first conductive layer 408, a second conductive layer 404, and an isolation layer 406 disposed between the first and second conductive layer 404, 408. A plurality of apertures 412 is formed by the open area of the first and second conductive layer 408, 404. A plurality of channels 402 served as fluid assist element is formed into the bottom surface of the second conductive layer 404. The channels 402 are laterally coupled at least two apertures 412 formed in the second conductive layer 404. Alternatively, the plurality of channels 502 may be formed at edges of the second conductive layer 504 to serve as fluid assist element facilitating the dynamic flow and circulation of the process fluid, as shown in FIG. 5. The channels 502 laterally couple to the apertures 512 formed through the first and second conductive layer 508, 504 that allows the spent process fluid in the apertures 512 to flush and clean away therethrough.

FIG. 6 depicts another embodiment of a pad assembly 600 with fluid flow assist element defined in a pad base 614. The pad base 614 has a plurality of channels 602 build into the upper surface of the pad base 614 to serve as fluid assist element. A portion of the channels 602 built in the pad base 614 have an opening exposed to apertures formed in the first and the second conductive layers 608, 604. Additionally, another potion of the channels 616 formed underneath the second conductive layer 604 is laterally coupled to a second end of the apertures formed through the second conductive layer 604. In embodiments that the pad base is not presented as shown in FIG. 7, the channels 702 may be build into the platen assembly 714 as needed. It is noted that the configuration, distribution, numbers, sides, and shapes of the channels in the present invention may be varied as needed.

Therefore, an apparatus with fluid flow assist element for electrochemical mechanical polishing is provided in this invention. The fluid flow assist element facilitates the dynamic flow and circulation of the process fluid, thereby advantageously maintaining a stable electrochemical activity in the system and a better control of the consumable parts maintenance.

While the foregoing is directed to the illustrative embodiment of the present invention, other and further embodiments of the invention may be devised without departing from the basic scope thereof, and the scope thereof is determined by the claims that follow.

What is claimed is:

1. An apparatus for electrochemical mechanical processing, comprising:
a first conductive layer having an upper surface adapted to contact a substrate;
a second conductive layer disposed below the first conductive layer;
an isolation layer disposed between the conductive layers; and
a plurality of apertures, each having a first end formed through the first conductive layer and a second end formed through the second conductive layer, wherein the second ends of at least two apertures are laterally coupled by a channel.

2. The apparatus of claim 1, wherein channel is formed in the second conductive layer.

3. The apparatus of claim 1, further comprising:
a pad base coupled to the second conductive layer, wherein the channel is formed therebetween.

4. The apparatus of claim 3, further comprising:
at least one post maintaining the pad base and the second conductive layer in a spaced-apart relation.

5. The apparatus of claim 1, wherein the channel has a flow path extending outward of the second conductive layer.

6. The apparatus of claim 1, wherein the first conductive layer grooves forward in the upper surface.

7. The apparatus of claim 6, wherein the first end of the aperture exits the first conductive layer below the upper surface within the groove.

8. The apparatus of claim 1, further comprising:
a platen coupled to the second conductive layer, wherein the channel is formed therebetween.

9. The apparatus of claim 8, further comprising:
at least one post maintaining the platen and the second conductive layer in a spaced-apart relation.

10. The apparatus of claim 1, wherein the first and second conductive layer are fabricated by a conductive layer selected from a group consisting of noble metals, soft corrosion resistive metals, polymer conductive material, stainless steel, aluminum and copper.

11. An apparatus for electrochemical mechanical processing, comprising:
a rotatable platen;
a removable pad assembly disposed on the platen; and
a fluid delivery system is positionable to provide process fluid to an upper surface of the pad assembly, the pad assembly further comprising:
a first conductive layer adapted to contact a substrate;
a second conductive layer;
an isolation layer separating the conductive layers, and
a plurality of fluid assist elements defining a lateral flow network below the second conductive layer.

12. The apparatus of claim 11, wherein fluid assist elements are channels formed in the second conductive layer.

13. The apparatus of claim 11, further comprising:
a pad base coupled to the second conductive layer, wherein the fluid assist element are formed therebetween.

14. The apparatus of claim 13, further comprising:
at least one post maintaining the pad base and the second conductive layer in a space-apart relation.

15. The apparatus of claim 11, further comprising:
a plurality of posts disposed on the platen maintaining the platen and the second conductive layer in a space-apart relation.

16. The apparatus of claim 11, wherein the fluid assist element defines a flow path extending outward of the second conductive layer.

17. The apparatus of claim 11, wherein the first and second conductive layer are fabricated by a conductive layer selected from a group consisting of noble metals, soft corrosion resistive metals, polymer conductive material, stainless steel, aluminum and copper.

18. An apparatus for electrochemical mechanical processing, comprising:
a first conductive layer having an upper surface adapted to contact a substrate;
a second conductive layer disposed below the first conductive layer;
an isolation layer disposed between the conductive layers; and
a plurality of posts having a first end disposed on a platen and a second end disposed below the second conductive layer and maintaining the platen and the second conductive layer in a space-apart relation.

19. A method for electrochemical mechanical processing, comprising:
contacting a top surface of a pad assembly disposed on a platen with a substrate;
flowing process fluid from the top surface of the pad assembly through apertures formed through the pad assembly toward the platen and into contact with an electrode;
draining the apertures through at least one of a bottom surface or side assembly; and
biasing the substrate relative to the electrode.

20. The method of claim 18, wherein the step of flowing process fluid further comprising:
flowing the process fluid through a lateral flow network defined below the to surface of the pad assembly and above the platen.
